(19) United States
(12) Patent Application Publication
(10) Pub. No.: US 2026/0178747 A1
(43) Pub. Date: Jun. 25, 2026

(54) SYSTEM AND METHOD FOR GENERATING REMEDIATION EVIDENCE OBJECT IN CLOUD PLATFORMS

(71) Applicants: SHUAIB AHMED, Bellevue, WA (US); MUSTAFA ALI MOHAMMED, Elmwood Park, NJ (US)

(72) Inventors: SHUAIB AHMED, Bellevue, WA (US); MUSTAFA ALI MOHAMMED, Elmwood Park, NJ (US)

(21) Appl. No.: 19/545,037

(22) Filed: Feb. 20, 2026

(51) Int. Cl. G06F 21/57; G06F 21/55; G06F 21/60

(52) U.S. Cl. CPC G06F 21/577; G06F 21/554; G06F 21/602

(57) ABSTRACT

A system (102) and method for generating remediation evidence object in cloud platforms. The method (300) includes receiving, by a vulnerability intelligence interface, at least one Known Exploited Vulnerability (KEV) record from one or more external threat intelligence repositories. The method includes correlating a plurality of cloud assets (104a, 104b, 104c . . . 104n) distributed across one or more cloud environments. The method includes generating an exposure mapping graph. The method includes computing a prioritized patch action set based on one or more of one or more exploit prevalence indicators, one or more asset criticality scores, and one or more service dependency constraints derived from the exposure mapping graph. The method includes executing deployment of one or more patches corresponding to the prioritized patch action set. The method includes determining one or more remediation state transitions based on the execution. The method includes generating the remediation evidence object.

### COPYRIGHT AND TRADEMARK NOTICE

This application includes material which is subject or may be subject to copyright and/or trademark protection. The copyright and trademark owner(s) have no objection to the facsimile reproduction by any of the patent disclosure, as it appears in the Patent and Trademark Office files or records, but otherwise reserves all copyright and trademark rights whatsoever.

### TECHNICAL FIELD

The present invention relates generally to field of cybersecurity and cloud infrastructure security vulnerability management. More particularly, to systems and methods for generating remediation evidence object in cloud platforms.

### BACKGROUND OF THE INVENTION

Cloud computing environments have become foundational to enterprise digital infrastructure, supporting distributed workloads across virtual machines, containerized services, serverless functions, and managed platform services. The operational cloud platforms introduce complex security management challenges, particularly in the identification and remediation of software vulnerabilities across dynamically scaling assets.

Conventional vulnerability management systems typically rely on periodic scanning mechanisms that identify software flaws based on publicly disclosed vulnerability repositories. Such systems generate extensive vulnerability records requiring remediation. However, not all disclosed vulnerabilities present equal risk. A subset of vulnerabilities, commonly classified as known exploited vulnerabilities, are actively weaponized and leveraged in real-world cyber intrusion campaigns. Traditional remediation frameworks do not consistently distinguish between theoretical vulnerabilities and actively exploited vulnerabilities when orchestrating patch deployment.

Existing patch management and remediation orchestration platforms exhibit structural limitations in correlating exploit intelligence with cloud asset exposure contexts. While certain systems provide vulnerability-to-asset mapping, such mapping is often static and does not account for runtime configuration states, service dependency relationships, or exploit propagation pathways within cloud service topologies. As a result, remediation prioritization is not reflect operational risk conditions present within active cloud environments.

Additionally, conventional remediation workflows rely heavily on administrative execution records, ticketing systems, or deployment logs to represent patch completion. The aforementioned records are susceptible to fragmentation, alteration, or loss, thereby limiting their reliability for post-remediation verification. Security compliance assessments and regulatory audits frequently require demonstrable proof that exploited vulnerabilities have been remediated, however, existing systems lack mechanisms to generate cryptographically verifiable remediation evidence bound to specific vulnerability closure events.

Further, contemporary solutions do not provide immutable assurance storage architectures capable of preserving remediation attestations in tamper-resistant formats. The absence of such evidentiary preservation mechanisms constrains forensic validation, regulatory reporting, and longitudinal security posture verification across multi-cloud deployments.

Therefore, there is need to develop a system and method to overcome aforementioned problems.

### SUMMARY OF THE INVENTION

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a method for generating remediation evidence object in cloud platforms is disclosed. The method includes receiving, by a vulnerability intelligence interface, at least one Known Exploited Vulnerability (KEV) record from one or more external threat intelligence repositories. The at least one KEV record comprises exploitability metadata and one or more affected software identifiers. The method includes correlating, by an asset discovery engine, the at least one KEV record with a plurality of cloud assets distributed across one or more cloud environments. The method includes generating an exposure mapping graph based on the correlation, wherein the exposure mapping graph encodes asset-to-vulnerability relationships based on one or more runtime configuration states and one or more software inventories. The method includes computing, by a remediation orchestration controller, a prioritized patch action set based on one or more of one or more exploit prevalence indicators, one or more asset criticality scores, and one or more service dependency constraints derived from the exposure mapping graph. The method includes executing, via one or more programmable cloud control plane interfaces, automated deployment of one or more patches corresponding to the prioritized patch action set across the plurality of cloud assets based on the computed prioritized patch action set. The method includes determining one or more remediation state transitions based on the execution. The method includes generating, by a cryptographically verifiable evidence engine, the remediation evidence object based on the determined one or more remediation state transitions.

In accordance with another embodiment of the present disclosure, a system for generating a remediation evidence object in cloud platforms is disclosed. The system includes at least one memory, at least one processor operatively connected to the at least one memory. The at least one processor is configured to receive, using a vulnerability intelligence interface, at least one KEV record from one or more external threat intelligence repositories. The at least one KEV record comprises exploitability metadata and one or more affected software identifiers. The at least one processor is configured to correlate, using an asset discovery engine, the at least one KEV record with a plurality of cloud assets distributed across one or more cloud environments. The at least one processor is configured to generate an exposure mapping graph based on the correlation, wherein the exposure mapping graph encodes asset-to-vulnerability relationships based on one or more runtime configuration states and one or more software inventories. The at least one processor is configured to compute, using a remediation orchestration controller, a prioritized patch action set based on one or more of one or more exploit prevalence indicators, one or more asset criticality scores, and one or more service dependency constraints derived from the exposure mapping graph. The at least one processor is configured to execute, via one or more programmable cloud control plane interfaces, automated deployment of one or more patches corresponding to the prioritized patch action set across the plurality of cloud assets based on the computed prioritized patch action set. The at least one processor is configured to determine one or more remediation state transitions based on the execution. The at least one processor is configured to generate, using a cryptographically verifiable evidence engine, the remediation evidence object based on the determined one or more remediation state transitions. The remediation evidence object comprises one or more patch execution logs, one or more asset state attestations, one or more timestamped deployment proofs, and one or more vulnerability closure confirmations.

In accordance with another embodiment of the present disclosure, a non-transitory computer-readable medium storing instructions that, when executed, cause a processor to receive, using a vulnerability intelligence interface, at least one KEV record from one or more external threat intelligence repositories. The at least one KEV record comprises exploitability metadata and one or more affected software identifiers. The processor is configured to correlate, using an asset discovery engine, the at least one KEV record with a plurality of cloud assets distributed across one or more cloud environments. The processor is configured to generate an exposure mapping graph based on the correlation, wherein the exposure mapping graph encodes asset-to-vulnerability relationships based on one or more runtime configuration states and one or more software inventories. The processor is configured to compute, using a remediation orchestration controller, a prioritized patch action set based on one or more of one or more exploit prevalence indicators, one or more asset criticality scores, and one or more service dependency constraints derived from the exposure mapping graph. The processor is configured to execute, via one or more programmable cloud control plane interfaces, automated deployment of one or more patches corresponding to the prioritized patch action set across the plurality of cloud assets based on the computed prioritized patch action set. The processor is configured to determine one or more remediation state transitions based on the execution. The processor is configured to generate, using a cryptographically verifiable evidence engine, the remediation evidence object based on the determined one or more remediation state transitions. The remediation evidence object comprises one or more patch execution logs, one or more asset state attestations, one or more timestamped deployment proofs, and one or more vulnerability closure confirmations.

One or more advantages of the prior art are overcome, and additional advantages are provided through the invention. Additional features are realized through the technique of the invention. Other embodiments and aspects of the disclosure are described in detail herein and are considered a part of the invention.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 illustrates a block diagram depicting an environment for establishing a system 102 for generating remediation evidence object in cloud platforms, in accordance with an embodiment of the present disclosure;

FIG. 2 is a block diagram depicting the system for generating the remediation evidence object in the cloud platforms, in accordance with an embodiment of the present disclosure; and

FIG. 3 illustrates a flowchart depicting a method for generating the remediation evidence object in the cloud platforms, in accordance with an embodiment of the present disclosure.

Skilled artisans will appreciate the elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed. It shall be understood that different aspects of the invention can be appreciated individually, collectively, or in combination with each other.

The present invention provides exploit-intelligence-based vulnerability remediation orchestration, patch assurance validation, and cryptographically verifiable remediation evidence generation within distributed cloud computing environments. The present invention generates exposure mapping structures reflecting exploitability contexts, orchestrating prioritized remediation deployment through cloud control plane mechanisms.

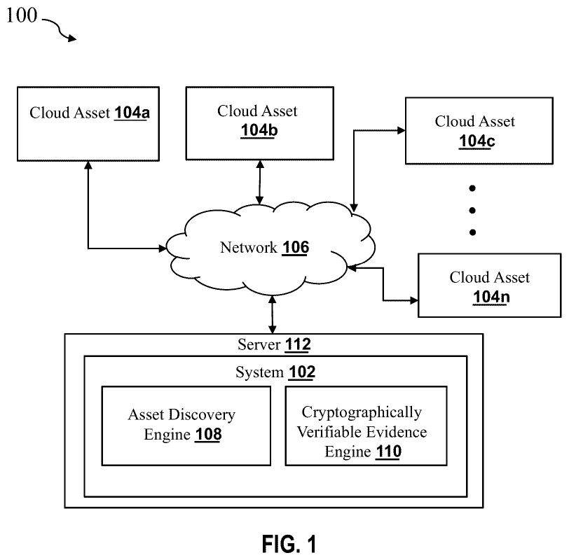

An environment and processes may be described with reference to FIG. 1 showing an architectural level schematic of a system in accordance with an implementation. Because FIG. 1 is an architectural diagram, certain details are intentionally omitted to improve the clarity of the description. The discussion of FIG. 1 will be organized as follows. First, the elements of the figure will be described, followed by their interconnections. Then, the use of the elements in the environment will be described in greater detail. The environment provides power of deep learning neural networks for data classification and clustering.

Referring now to the drawings, and more particularly to FIG. 1 through FIG. 3, where similar reference characters denote corresponding features consistently throughout the figures, there are shown preferred embodiments and these embodiments are described in the context of the following exemplary system and/or method.

FIG. 1 illustrates a block diagram depicting an environment 100 for establishing a system 102 for generating remediation evidence object in cloud platforms, in accordance with an embodiment of the present disclosure. The cloud platforms may include distributed, virtualized computing infrastructures implemented through geographically dispersed data center hardware resources configured to provide on-demand computational, storage, and networking capabilities. The cloud platforms may be configured to operate through coordinated hardware and software control layers that enable provisioning, execution, monitoring, and remediation of computational assets.

According to FIG. 1, the environment 100 includes the system 102, a plurality of cloud assets 104a, 104b, 104c . . . 104n, a network 106, and a server 112. The network 106 may include an internet. The network 106 may be rapidly emerging as a preferred system for distributing and exchanging data. The network 106 may include a cellular network, a public land mobile network (PLMN), a second generation (2G) network, a third generation (3G) network, a fourth generation (4G) network (e.g., a long-term evolution (LTE) network), a fifth generation (5G) network, and/or another network. Additionally, or alternatively, the network 106 may include a wide area network (WAN), a metropolitan network (MAN), a telephone network (e.g., the Public Switched Telephone Network (PSTN)), an ad hoc network, an intranet, an Internet, a fiber optic-based network, and/or a combination of these or other types of networks.

The system 102 may include an asset discovery engine 108 and a cryptographically verifiable evidence engine 110. In an embodiment, the system 102 may be established within the server 112. In another embodiment, the system 102 may be externally connected to the server 112. Yet in anther embodiment, some part of the system 102 may be implemented within the server 112 and remaining part of the system 102 may be externally connected to the server 112. The server 112 may include, but is not limited to, one or more Graphical Processing Units (GPUs), one or more Tensor Processing Units (TPUs), and one or more Central Processing Units (CPU), and the like.

In an embodiment, the system 102 may be configured to receive at least one Known Exploited Vulnerability (KEV) record using a vulnerability intelligence interface from one or more external threat intelligence repositories. The at least one KEV record may include exploitability metadata and one or more affected software identifiers. The one or more affected software identifiers may include, but are not limited to, common platform enumeration identifiers, software bill of materials components, package manager identifiers, container image digests, runtime library fingerprints, and the like.

Further, the system 102 may include the asset discovery engine 108 configured to correlate the at least one KEV record with the plurality of cloud assets 104a, 104b, 104c . . . 104n (referred to herein as cloud assets 104a, 104b, 104c . . . 104n) distributed across one or more cloud environments. The cloud assets 104a, 104b, 104c . . . 104n may include, but are not limited to, virtual machines, containerized workloads, serverless functions, managed databases, platform service instances deployed across multi-cloud or hybrid cloud environments, and the like.

Furthermore, the system 102 may be configured to generate an exposure mapping graph based on the correlation. The exposure mapping graph may include a machine-generated relational data structure encodes one or more asset nodes, one or more vulnerability nodes, one or more dependency edges, and one or more exploit path propagation linkages. The exposure mapping graph may encode asset-to-vulnerability relationships based on the one or more runtime configuration states and the one or more software inventories. The runtime configuration states may include, but are not limited to, operating system versions, kernel patch levels, container runtime parameters, network exposure policies, identity and access privilege assignments, and the like.

In addition, the system 102 may be configured to compute a prioritized patch action set using a remediation orchestration controller based on one or more of one or more exploit prevalence indicators, one or more asset criticality scores, and one or more service dependency constraints derived from the exposure mapping graph.

The system 102 may be configured to execute automated deployment of one or more patches corresponding to the prioritized patch action set across the cloud assets 104a, 104b, 104c . . . 104n via one or more programmable cloud control plane interfaces based on the computed prioritized patch action set. The one or more programmable cloud control plane interfaces may include, but are not limited to, orchestration interfaces, container orchestration control APIs, serverless deployment managers, virtual machine management endpoints, and the like.

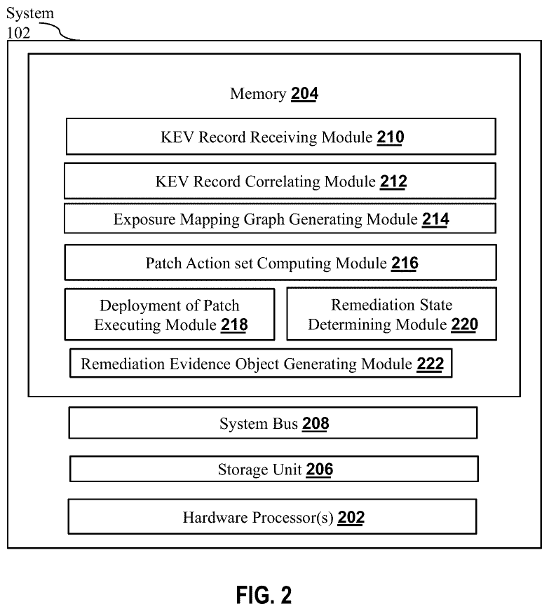

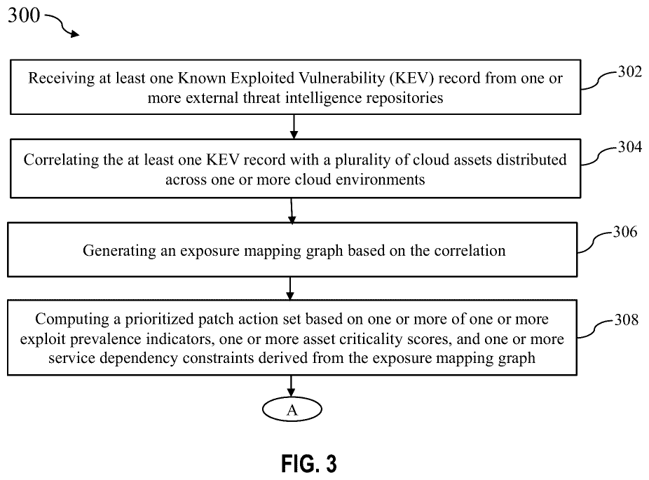

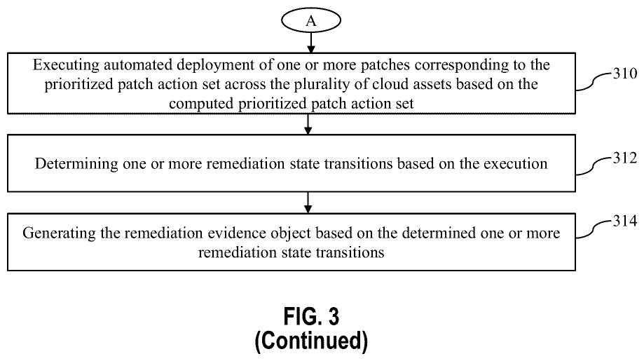

The system 102 may be configured to determine one or more remediation state transitions based on the execution. In an embodiment, the system 102 may be configured to monitor one or more post-deployment configuration states and one or more patch installation artifacts from the cloud assets 104a, 104b, 104c . . . 104n to determine remediation state transitions. Further, the system 102 may include the cryptographically verifiable evidence engine 110 configured to generate the remediation evidence object based on the determined one or more remediation state transitions. The remediation evidence object may include, but are not limited to, one or more patch execution logs, one or more asset state attestations, one or more timestamped deployment proofs, one or more vulnerability closure confirmations, and the like. The system 102 has been further detailed with reference to FIG. 2 and FIG. 3.

FIG. 2 illustrates a block diagram depicting the system 102 for generating the remediation evidence object in the cloud platforms, in accordance with an embodiment of the present disclosure.

According to FIG. 2, the system 102 may include one or more hardware processors 202, a memory 204 and a storage unit 206. The one or more hardware processors 202 (referred to hereinafter as a processor 202), the memory 204 and the storage unit 206 may be communicatively coupled through a system bus 208 or any similar mechanism. The system 102 implementing known exploited vulnerability-based patch assurance and remediation evidence generation is realized through a computing apparatus. The aforementioned hardware elements operate cooperatively to execute exploit-intelligence correlation, remediation orchestration, and evidence generation workflows within cloud platform environments.

The processor 202 may include one or more hardware processing units configured to execute machine-readable instructions associated with vulnerability intelligence processing, exposure graph computation, remediation orchestration, and cryptographic evidence generation. The processor 202 may include multi-core central processing units (CPUs), Graphics processing units (GPUs) configured for graph computation acceleration, Tensor or neural processing units where exploit prediction models are employed, Field-programmable gate arrays (FPGAs) configured for telemetry parsing or baseline comparison acceleration.

Within the present disclosure, the processor 202 may be configured to execute instructions to correlate KEV records with asset inventories, generate exposure mapping graphs, compute remediation priority scores, orchestrate automated patch deployment, and generate cryptographically verifiable remediation evidence objects.

The memory 204 may include volatile and non-volatile semiconductor memory configured to store executable instructions and operational datasets required for real-time remediation assurance processing. The memory 204 may include, but is not limited to, Dynamic random-access memory (DRAM), Synchronous DRAM (SDRAM), Double data rate (DDR) memory modules, Static random-access memory (SRAM) caches, Non-volatile memory such as NVRAM, and the like. The memory 204 may be configured to store KEV intelligence datasets, asset telemetry buffers, runtime configuration states, exposure graph intermediate structures, remediation orchestration queues, and evidence object assembly data prior to persistent storage.

The storage unit 206 may include persistent, non-transitory storage media configured to retain vulnerability intelligence repositories, asset state histories, remediation artifacts, and cryptographically verifiable evidence records. The storage unit 206 may include Solid-state drives (SSDs), Hard disk drives (HDDs), Network-attached storage (NAS) arrays, Storage area networks (SANs), Object storage systems, and append-only or ledger-based storage infrastructures.

Within the present disclosure, the storage unit 206 may be configured to store historical KEV ingestion records, software inventory databases, exposure mapping graphs, patch deployment logs, pre- and post-remediation baselines, and immutable remediation evidence objects.

The system bus 208 may include high-speed communication pathways enabling data exchange among the processor 202, the memory 204, the storage unit 206, and network interface subsystems. The system bus 208 may include Peripheral Component Interconnect Express (PCIe) buses, Serial Advanced Technology Attachment (SATA) buses, Non-Volatile Memory Express (NVMe) interconnects, Industry Standard Architecture (ISA) buses, and High-speed fabric interconnects within clustered processing systems.

Within the present disclosure, the system bus 208 facilitates transfer of KEV datasets from storage to processing memory, streaming of telemetry inputs to graph computation engines, transmission of remediation execution instructions, movement of cryptographic evidence data to ledger storage, and coordination of baseline comparison operations.

The storage unit 206 may retain KEV intelligence and asset telemetry. The system bus 208 transfers datasets into memory 204. The processor 202 executes correlation, prioritization, and orchestration instructions. Evidence artifacts are generated and written back to storage unit 206, including immutable ledger repositories.

The memory 204 may include a KEV record receiving module 210, a KEV record correlating module 212, an exposure mapping graph generating module 214, a patch action set computing module 216, a deployment of patch executing module 218, a remediation state determining module 220, and a remediation evidence object generating module 222.

The KEV record receiving module 210 may be configured to receive the known exploited vulnerability records from one or more external threat intelligence repositories through secure network communication interfaces. The KEV record receiving module 210 includes protocol processing circuitry and feed ingestion logic executed by one or more processors to receive structured vulnerability intelligence streams comprising exploitability metadata and affected software identifiers. The received KEV records may include active exploitation indicators, exploit weaponization timestamps, and threat campaign references. The KEV record receiving module 210 further normalizes heterogeneous feed formats into standardized machine-readable data structures and stores the processed KEV datasets within vulnerability intelligence repositories accessible to downstream processing modules.

In an example scenario, a cloud security environment subscribes to multiple exploit intelligence feeds. The KEV record receiving module 210 retrieves a newly disclosed vulnerability actively exploited in web application frameworks. The module parses the feed, extracts exploit availability indicators and affected software package identifiers, and stores the normalized KEV record for correlation with enterprise cloud assets.

The KEV record correlating module 212 may be configured to correlate the received KEV records with computational assets distributed across the cloud platforms. The KEV record correlating module 212 may be configured to access asset telemetry repositories containing software inventories, operating system attributes, and runtime configuration states. Using identifier matching, package fingerprinting, and version comparison operations, the module determines which assets include software components affected by the received KEV records. Correlation results are compiled into asset-vulnerability association datasets that form the basis for exposure modeling and remediation prioritization.

In an example scenario, following ingestion of a KEV affecting a container runtime library, the correlating module scans asset inventories collected from container orchestration clusters. The KEV record correlating module 212 identifies multiple production containers running vulnerable library versions and associates the KEV record with those containerized workloads.

The exposure mapping graph generating module 214 may be configured to construct machine-generated relational graph structures representing exploit exposure relationships. The exposure mapping graph generating module 214 may be configured to process correlation outputs together with service topology data, dependency mappings, and network communication pathways to generate an exposure mapping graph comprising asset nodes, vulnerability nodes, dependency edges, and exploit propagation linkages. Graph computation engines within the module enable traversal of lateral movement paths and identification of cascading exploit risk conditions across interconnected cloud services.

In an example scenario, a vulnerable authentication service identified by the KEV record correlating module 212 is found to be connected to multiple downstream financial processing services. The exposure mapping graph generating module 214 may be construct dependency edges showing that exploitation of the authentication service could propagate unauthorized access to payment systems, thereby elevating remediation priority.

The patch action set computing module 216 may be configured to compute a prioritized remediation action set based on exploit intelligence and exposure context. The patch action set computing module 216 may be configured to apply weighted scoring models incorporating exploit prevalence indicators, asset criticality scores, and service dependency constraints derived from the exposure mapping graph. Priority computation processors generate sequenced patch deployment plans that account for operational impact, service uptime requirements, and dependency ordering constraints.

In an example scenario, where two vulnerable assets are identified one hosting customer data and another operating in a development environment the patch action set computing module assigns higher remediation priority to the customer-facing production system due to higher criticality and external exposure.

The deployment of patch executing module 218 may be configured to execute automated remediation deployment across affected cloud assets via programmable control plane interfaces. The deployment of patch executing module 218 may be configured to interface with infrastructure orchestration gateways, configuration management systems, and container orchestration masters to deploy patch artifacts, rebuild images, or update runtime packages. Execution workflows may be performed through infrastructure-as-code pipelines or automated configuration enforcement mechanisms.

In an example scenario, upon receiving a prioritized patch action set, a deployment module triggers automated rebuilding of vulnerable container images, redeploys patched containers into production clusters, and applies operating system patches to associated virtual machines through control plane Application Programming Interfaces (APIs).

The remediation state determining module 220 may be configured to determine remediation state transitions by evaluating configuration and software states before and after patch deployment. The remediation state determining module 220 may be configured to capture pre-deployment baselines, including vulnerable software versions and configuration parameters, and compares them with post-deployment states collected through telemetry inspection and installation artifact analysis. Based on comparative evaluation, the remediation state determining module 220 may be configured to determine whether assets have transitioned from vulnerable states to remediated states.

In an example scenario, after patch deployment, the remediation state determining module 220 may be configured to retrieve updated package manifests from remediated servers and verifies that vulnerable software versions have been replaced. Where updated versions match secure baselines, the the remediation state determining module 220 may be configured to record a successful remediation state transition.

The remediation evidence object generating module 222 may be configured to generate cryptographically verifiable evidence records corresponding to determined remediation state transitions. The remediation evidence object generating module 222 may be configured to aggregate patch execution logs, asset state attestations, deployment timestamps, and vulnerability closure confirmations into structured evidence objects. Cryptographic processors within the module generate hash values, digital signatures, and time-bound attestations to ensure integrity and non-repudiation of remediation proof records.

In an example scenario, following confirmation that a critical KEV has been remediated across production assets, the module compiles installation logs, configuration snapshots, and validation results into a signed remediation evidence object, which can subsequently be stored in an immutable assurance ledger for audit verification.

FIG. 3 illustrates a flowchart depicting a method 300 for generating the remediation evidence object in the cloud platforms, in accordance with an embodiment of the present disclosure.

At step 302, the method 300 may include receiving, by the vulnerability intelligence interface, the at least one Known Exploited Vulnerability (KEV) record from the one or more external threat intelligence repositories. The at least one KEV record may include exploitability metadata and one or more affected software identifiers. The exploitability metadata may include active exploitation status, one or more exploit availability indicators, one or more threat actor attribution tags, one or more exploit weaponization timestamps, and one or more severity scoring parameters. The one or more affected software identifiers may include software package names, version identifiers, common platform enumeration entries, container image references, or software bill of materials components. The interface normalizes heterogeneous feed formats into structured datasets for downstream correlation processing.

In an example scenario, national cybersecurity agency publishes a KEV advisory identifying an actively exploited vulnerability in a widely used web server package. The vulnerability intelligence interface retrieves the advisory through a structured vulnerability feed, extracts exploit availability indicators and affected package versions, and stores the KEV record in a local intelligence repository.

In an embodiment, the method 300 may include receiving, by the vulnerability intelligence interface, the at least one at least one KEV record through one or more of the structured vulnerability feed, an application programming interface, a machine-readable exploit alert stream, and a security advisory repository synchronization channel.

At step 304, the method 300 may include correlating, by the asset discovery engine, the at least one KEV record with the cloud assets distributed across the one or more cloud environments.

The asset discovery engine 108 may be configured to aggregate telemetry obtained through agent-based scanners, agentless inspection tools, and cloud control plane inventory queries. The one or more software inventories, operating system builds, runtime libraries, and container manifests are analyzed to identify assets containing software components matching the affected software identifiers within the KEV record. Correlation outputs identify vulnerable assets and establish asset-vulnerability association datasets. In an example scenario, the asset discovery engine scans container registries and running workloads across multiple clusters. It identifies that several production containers are running the vulnerable web server version referenced in the KEV record and flags those containers as exposed assets.

At step 306, the method 300 may include generating the exposure mapping graph based on the correlation. The exposure mapping graph encodes asset-to-vulnerability relationships based on the one or more runtime configuration states and the one or more software inventories.

The exposure mapping graph further incorporates service topology data, inter-asset communication pathways, and dependency relationships to model exploit propagation linkages. Graph generation processors organize assets and vulnerabilities into nodes connected by dependency and exposure edges, enabling computational traversal of exploit paths.

The exposure mapping graph reveals that the vulnerable web server containers interface with authentication microservices and backend financial databases. Dependency edges indicate that exploitation of the web server may provide attackers lateral access to sensitive financial processing systems.

At step 308, the method 300 may include computing, by the remediation orchestration controller, the prioritized patch action set based on the one or more of one or more exploit prevalence indicators, the one or more asset criticality scores, and the one or more service dependency constraints derived from the exposure mapping graph.

The controller executes priority scoring module that weigh factors such as active exploitation volume, external network exposure, data sensitivity, and dependency sequencing requirements. The resulting patch action set defines ordered remediation tasks specifying which assets should be patched and in what sequence. In an example scenario, although development and production systems run the vulnerable software, the controller assigns higher priority to internet-facing production servers hosting customer data, while deferring lower-risk internal development systems.

At step 310, the method 300 may include executing, via the one or more programmable cloud control plane interfaces, deployment of the one or more patches corresponding to the prioritized patch action set across the cloud assets based on the computed prioritized patch action set.

Deployment workflows may involve operating system patch installation, application package upgrades, container image rebuilding, or infrastructure-as-code redeployment. Execution processors transmit authenticated deployment commands and monitor rollout progress. The system 102 triggers automated rebuilding of container images with patched web server versions, redeploys updated containers into production clusters, and applies operating system security patches to supporting virtual machines.

At step 312, the method 300 may include determining the one or more remediation state transitions based on the execution. A remediation validation subsystem captures pre-deployment configuration baselines and compares them with post-deployment states collected through telemetry and installation artifacts. Configuration comparison engines verify whether vulnerable software versions have been replaced and whether remediation actions have been successfully applied. Determined state transitions indicate movement from vulnerable states to remediated states.

In an example scenario, following deployment, the system 102 retrieves updated software manifests and confirms that the vulnerable web server version has been replaced across all targeted containers. Assets meeting secure configuration baselines are marked as remediated.

At step 314, the method 300 may include generating, by the cryptographically verifiable evidence engine, the remediation evidence object based on the determined one or more remediation state transitions.

The evidence engine aggregates patch execution logs, asset state attestations, deployment timestamps, and vulnerability closure confirmations into structured evidence records. Cryptographic processors generate hash values and digital signatures to ensure integrity and authenticity of the evidence object. The generated evidence object constitutes verifiable proof that the KEV-associated vulnerabilities have been remediated.

In an example scenario, for the remediated web server vulnerability, the system 102 compiles deployment logs, configuration snapshots, and validation results into a signed remediation evidence object. The signed remediation evidence object is subsequently stored in an assurance repository to support audit verification and compliance reporting.

The method 300 may include storing the remediation evidence object within the immutable assurance ledger to enable audit-ready verification of KEV remediation across the cloud platforms based on the generated remediation evidence object.

In an embodiment, for correlating the at least one known exploited vulnerability record with the plurality of cloud assets, the method 300 may include mapping the affected software identifiers to the one or more software inventories obtained through agent-based scanning, agentless inspection, or control plane telemetry extraction.

In an embodiment, for computing the prioritized patch action set, the method 300 may include computing a composite remediation priority score based on weighted aggregation of the exploit prevalence indicators, asset criticality scores, and service dependency constraints.

In an embodiment, executing, by the remediation orchestration controller, a multi-factor prioritization computation that aggregates exploit intelligence signals, asset risk attributes, and service dependency relationships into a unified remediation ranking metric. The remediation orchestration controller may retrieve exploit prevalence indicators associated with each known exploited vulnerability from vulnerability intelligence repositories. The exploit prevalence indicators quantify real-world exploitation activity and may include metrics such as observed attack frequency, exploit campaign distribution, active exploitation confirmation status, exploit automation availability, and temporal recency of exploit weaponization. These indicators are normalized into exploit prevalence values using statistical scaling or threat intelligence weighting models.

Concurrently, the remediation orchestration controller may retrieve asset criticality scores corresponding to computational assets correlated with the vulnerability. The asset criticality scores may be derived from enterprise risk classification frameworks and may be computed based on data sensitivity levels, production service roles, regulatory compliance scope, business operational impact, external accessibility, and identity privilege exposure. Asset metadata repositories and configuration management databases provide inputs for criticality scoring, which are normalized into comparable numerical scales.

The remediation orchestration controller may be configured to evaluate service dependency constraints derived from the exposure mapping graph. Dependency constraints represent operational and architectural relationships that influence remediation sequencing and impact propagation. Such constraints include upstream and downstream service linkages, workload co-location dependencies, authentication trust relationships, and network communication pathways. Dependency weighting factors may reflect whether remediation of a given asset affects availability of dependent services or whether exploitation of one asset provides lateral access to others.

In an example scenario, consider a known exploited vulnerability affecting an operating system library deployed across multiple cloud assets. Exploit prevalence analysis indicates that the vulnerability is actively exploited in automated ransomware campaigns, yielding a high exploit prevalence value. The remediation orchestration controller aggregates these weighted factors and computes a higher composite remediation priority score for the production authentication asset relative to the testing asset. Based on this computation, the system 102 schedules patch deployment for the production asset ahead of lower-priority environments.

In an embodiment, the method 300 may include executing the one or more patches through one or more infrastructure-as-code pipelines, one or more configuration management frameworks, and one or more container image rebuild workflows exposed via the one or more programmable cloud control plane interfaces. The programmable cloud control plane interfaces may include, but is not limited to, compute orchestration interfaces, container orchestration control APIs, serverless deployment managers, or virtual machine management endpoints.

In an embodiment, for determining remediation state transitions, the method 300 may include determining a transition from a vulnerable state to a remediated state based on comparison of a pre-deployment configuration baseline and a post-deployment configuration baseline.

The methods may be implemented in any suitable hardware, software, firmware, or combination thereof.

Thus, various embodiments of the present invention provide the system for the generating remediation evidence object in the one or more cloud platforms.

The present invention provides multiple technical contributions in the domain of vulnerability remediation assurance within cloud computing infrastructures. The present invention enables remediation prioritization based on real-world exploitation activity rather than solely on theoretical vulnerability severity scores. The present invention facilitates computation of remediation action sets aligned to active threat conditions observed across external threat intelligence ecosystems.

The present invention provides machine-generated mappings of vulnerability exposure across distributed cloud environments. The present invention enables identification of vulnerable assets operating within heterogeneous execution contexts including virtual machines, containers, and serverless workloads. The present invention enables computational analysis of lateral exploit risk, inter-service trust relationships, and cascading compromise conditions within multi-tier cloud architectures.

The present invention computes composite remediation priority scores through weighted aggregation of exploit prevalence indicators, asset criticality scores, and service dependency constraints. The present invention supports sequenced remediation deployment planning reflecting operational risk distribution and infrastructure interdependencies. The present invention enables coordinated remediation execution across distributed cloud assets without reliance on manual intervention workflows. The present invention determines remediation state transitions by comparing pre-deployment and post-deployment configuration baselines. The present invention verifies that vulnerable software states have been replaced and that remediation actions have been successfully applied at the configuration level.

The present invention generates structured evidence objects comprising patch execution logs, asset state attestations, timestamped deployment records, and vulnerability closure confirmations. Cryptographic hashing and digital signature operations ensure integrity, authenticity, and non-repudiation of remediation evidence artifacts.

The present invention enables machine-verifiable audit validation of vulnerability closure events across cloud environments. This supports regulatory inspection, security certification processes, and operational assurance verification. The present invention supports remediation orchestration across geographically distributed and multi-cloud infrastructures. Federated deployment coordination and evidence aggregation enable unified remediation assurance despite segmented control plane domains and regionally distributed computational assets.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus 208 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. A method for generating remediation evidence object in cloud platforms, the method comprising:
receiving, by a vulnerability intelligence interface, at least one Known Exploited Vulnerability (KEV) record from one or more external threat intelligence repositories, wherein the at least one KEV record comprises exploitability metadata and one or more affected software identifiers;
correlating, by an asset discovery engine, the at least one KEV record with a plurality of cloud assets distributed across one or more cloud environments;
generating an exposure mapping graph based on the correlation, wherein the exposure mapping graph encodes asset-to-vulnerability relationships based on one or more runtime configuration states and one or more software inventories;
computing, by a remediation orchestration controller, a prioritized patch action set based on one or more of one or more exploit prevalence indicators, one or more asset criticality scores, and one or more service dependency constraints derived from the exposure mapping graph;
executing, via one or more programmable cloud control plane interfaces, deployment of one or more patches corresponding to the prioritized patch action set across the plurality of cloud assets based on the computed prioritized patch action set;
determining one or more remediation state transitions based on the execution; and
generating, by a cryptographically verifiable evidence engine, the remediation evidence object based on the determined one or more remediation state transitions.

2. The method of claim 1, comprising:
storing the remediation evidence object within an immutable assurance ledger to enable audit-ready verification of KEV remediation across the cloud platforms based on the generated remediation evidence object.

3. The method of claim 1, wherein receiving the at least one KEV record comprises:
receiving, by the vulnerability intelligence interface, the at least one at least one KEV record through one or more of a structured vulnerability feed, an application programming interface, a machine-readable exploit alert stream, and a security advisory repository synchronization channel.

4. The method of claim 1, wherein the exploitability metadata comprises one or more of an active exploitation status, one or more exploit availability indicators, one or more threat actor attribution tags, one or more exploit weaponization timestamps, and one or more severity scoring parameters.

5. The method of claim 1, wherein correlating the at least one known exploited vulnerability record with the plurality of cloud assets comprises:
mapping the affected software identifiers to the one or more software inventories obtained through agent-based scanning, agentless inspection, or control plane telemetry extraction.

6. The method of claim 1, wherein computing the prioritized patch action set comprises:
computing a composite remediation priority score based on weighted aggregation of the exploit prevalence indicators, asset criticality scores, and service dependency constraints.

7. The method of claim 1, wherein executing the deployment of the one or patches comprises:
executing the one or more patches through one or more infrastructure-as-code pipelines, one or more configuration management frameworks, and one or more container image rebuild workflows exposed via the one or more programmable cloud control plane interfaces.

8. The method of claim 1, wherein determining remediation state transitions comprises:
determining a transition from a vulnerable state to a remediated state based on comparison of a pre-deployment configuration baseline and a post-deployment configuration baseline.

9. The method of claim 1, wherein the exposure mapping graph comprises a machine-generated relational data structure encodes one or more asset nodes, one or more vulnerability nodes, one or more dependency edges, and one or more exploit path propagation linkages.

10. The method of claim 1, wherein the remediation evidence object comprises one or more patch execution logs, one or more asset state attestations, one or more timestamped deployment proofs, and one or more vulnerability closure confirmations.

11. A system for generating a remediation evidence object in cloud platforms, the system comprising:
at least one memory;
at least one processor operatively connected to the at least one memory, wherein the at least one processor is configured to:
receive, using a vulnerability intelligence interface, at least one KEV record from one or more external threat intelligence repositories, wherein the at least one KEV record comprises exploitability metadata and one or more affected software identifiers;
correlate, using an asset discovery engine, the at least one KEV record with a plurality of cloud assets distributed across one or more cloud environments;
generate an exposure mapping graph based on the correlation, wherein the exposure mapping graph encodes asset-to-vulnerability relationships based on one or more runtime configuration states and one or more software inventories;
compute, using a remediation orchestration controller, a prioritized patch action set based on one or more of one or more exploit prevalence indicators, one or more asset criticality scores, and one or more service dependency constraints derived from the exposure mapping graph;
execute, via one or more programmable cloud control plane interfaces, deployment of one or more patches corresponding to the prioritized patch action set across the plurality of cloud assets based on the computed prioritized patch action set;
determine one or more remediation state transitions based on the execution; and
generate, using a cryptographically verifiable evidence engine, the remediation evidence object based on the determined one or more remediation state transitions, wherein the remediation evidence object comprises one or more patch execution logs, one or more asset state attestations, one or more timestamped deployment proofs, and one or more vulnerability closure confirmations.

12. The system of claim 11, wherein the at least one processor is configured to:
store, using the memory, the remediation evidence object within an immutable assurance ledger to enable audit-ready verification of KEV remediation across the cloud platforms based on the generated remediation evidence object.

13. The system of claim 11, wherein to receive the at least one KEV record, the at least one processor is configured to:
receive, using the vulnerability intelligence interface, the at least one at least one KEV record through one or more of a structured vulnerability feed, an application programming interface, a machine-readable exploit alert stream, and a security advisory repository synchronization channel.

14. The system of claim 11, wherein the exploitability metadata comprises one or more of an active exploitation status, one or more exploit availability indicators, one or more threat actor attribution tags, one or more exploit weaponization timestamps, and one or more severity scoring parameters.

15. The system of claim 11, wherein to correlate the at least one known exploited vulnerability record with the plurality of cloud assets, the at least one processor is configured to:
map the affected software identifiers to the one or more software inventories obtained through agent-based scanning, agentless inspection, or control plane telemetry extraction.

16. The system of claim 11, wherein to compute the prioritized patch action set, the at least one processor is configured to:
compute a composite remediation priority score based on weighted aggregation of the exploit prevalence indicators, asset criticality scores, and service dependency constraints.

17. The system of claim 11, wherein to execute the deployment of the one or patches, the at least one processor is configured to:
execute the one or more patches through one or more infrastructure-as-code pipelines, one or more configuration management frameworks, and one or more container image rebuild workflows exposed via the one or more programmable cloud control plane interfaces.

18. The system of claim 11, wherein to determine remediation state transitions, the at least one processor is configured to:
determine a transition from a vulnerable state to a remediated state based on comparison of a pre-deployment configuration baseline and a post-deployment configuration baseline.

19. The system of claim 11, wherein the exposure mapping graph comprises a machine-generated relational data structure encodes one or more asset nodes, one or more vulnerability nodes, one or more dependency edges, and one or more exploit path propagation linkages.

20. A non-transitory computer-readable medium storing instructions that, when executed, cause a processor to:
receive, using a vulnerability intelligence interface, at least one KEV record from one or more external threat intelligence repositories, wherein the at least one KEV record comprises exploitability metadata and one or more affected software identifiers;
correlate, using an asset discovery engine, the at least one KEV record with a plurality of cloud assets distributed across one or more cloud environments;
generate an exposure mapping graph based on the correlation, wherein the exposure mapping graph encodes asset-to-vulnerability relationships based on runtime configuration states and one or more software inventories;
compute, using a remediation orchestration controller, a prioritized patch action set based on one or more of one or more exploit prevalence indicators, one or more asset criticality scores, and one or more service dependency constraints derived from the exposure mapping graph;
execute, via one or more programmable cloud control plane interfaces, deployment of one or more patches corresponding to the prioritized patch action set across the plurality of cloud assets based on the computed prioritized patch action set;
determine one or more remediation state transitions based on the execution; and
generate, using a cryptographically verifiable evidence engine, the remediation evidence object based on the determined one or more remediation state transitions, wherein the remediation evidence object comprises one or more patch execution logs, one or more asset state attestations, one or more timestamped deployment proofs, and one or more vulnerability closure confirmations.
